(19) United States
(12) Patent Application Publication
(10) Pub. No.: US 2008/0005039 A1
(43) Pub. Date: Jan. 3, 2008

(54) Decryption of Personal Identification Number & Forwarding Method and Apparatus

(75) Inventors: Devarajan PUTHUPPARAMBIL, Mt. Prospect, IL (US); J SCHNEIDER, Grayslake, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTSTARCOM, INC., Alameda, CA (US)

(21) Appl. No.: 11/425,187

(22) Filed: Jun. 20, 2006

(51) Int. Cl. H04L 9/00

(52) U.S. Cl. 705/72

(57) ABSTRACT

An Internet Protocol-compatible network element (100) provides PIN encryption key information to a PIN enabled device (102) and then receives from that PIN enabled device a message that comprises both information regarding a transaction to be authorized as well as encrypted information that comprises a corresponding PIN that has been encrypted using the PIN encryption key information. The Internet Protocol-compatible network element then decrypts the encrypted information to provide a recovered PIN and forwards the information regarding the transaction along with the recovered PIN to a transaction authorization host (103) that comprises a discrete network element with respect to the Internet Protocol-compatible network element.

### TECHNICAL FIELD

This invention relates generally to the decryption and forwarding of personal identification numbers as are provided by a personal identification number enabled device.

### BACKGROUND

Personal information numbers (PINs) are known in the art and often comprise, for example, a four digit numeric sequence of choice. Such PINs often serve to authenticate that a particular proposed financial transaction has been legitimately initiated by an authorized party. For example, by one known approach, a consumer can enter their PIN at a point-of-sale (POS) terminal that comprises, or is otherwise operably coupled to, a PIN enabled device. The PIN is encrypted and transmitted, along with information regarding a transaction to be authenticated, via a dial-based transmission to a transaction authorization host. The latter then decrypts the PIN and uses the recovered PIN to facilitate the authorization process.

Such a process indeed works as intended and finds instantiation in such examples as the EIS 1080 standard that defines the basic data formats for Visa transactions. There are, however, at least some application settings where this prior art approach offers a less than fully acceptable solution. The aforementioned decryption process, for example, often comprises a relatively computationally intense activity. This, in turn, can comprise a surprisingly significant portion of the workload of a given transaction authorization host. As a result, the computational requirements of decrypting PINs in accord with the requirements of, for example, EIS 1080 can become a point of limitation with respect to how many PIN enabled devices can be reasonably supported by a given transaction authorization host.

### BRIEF DESCRIPTION OF THE DRAWINGS

The above needs are at least partially met through provision of the personal identification number decryption method and apparatus described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a flow diagram as configured in accordance with various embodiments of the invention; and

FIG. 5 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, an Internet Protocol-compatible network element can provide PIN encryption key information to a PIN enabled device and then receive from that PIN enabled device a message that comprises both information regarding a transaction to be authorized as well as encrypted information that comprises a corresponding PIN that has been encrypted using the PIN encryption key information. The Internet Protocol-compatible network element then decrypts the encrypted information to provide a recovered PIN and forwards the information regarding the transaction along with the recovered PIN to a transaction authorization host that comprises a discrete network element with respect to the Internet Protocol-compatible network element.

There are various approaches by which such forwarding can be accomplished. For example, integrated or segregated messages can serve in this regard. As another example, this forwarding, in whole or in part, can be essentially asynchronous or can be provided in response to a message that is received from the transaction authorization host. By one approach, if desired, the recovered PIN can be re-encrypted using an encryption key shared with the authorization host, that is different than the aforementioned PIN encryption key before forwarding that information to the transaction authorization host.

So configured, the task of decrypting the PIN as sourced by the PIN enabled device falls to a network element other than the transaction authorization host. This, in turn, can provide considerable computational relief to the transaction authorization host. As noted, the PIN can be re-encrypted prior to forwarding it to the transaction authorization host, but this re-encryption can be effected in a less computationally-intensive manner and hence avoid the levels of computational loading that tend to characterize past efforts in this regard.

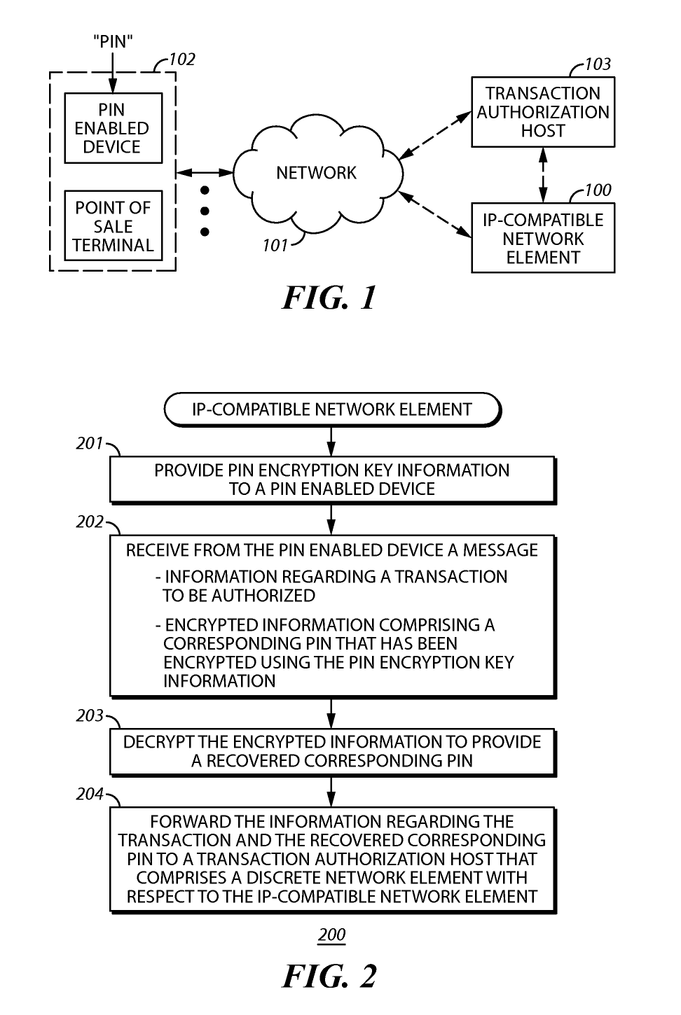

These and other benefits may become clearer upon making a thorough review and study of the following detailed description. Referring now to the drawings, and in particular to FIG. 1, these teachings are generally applicable for use with an Internet Protocol-compatible network element 100 that is configured and arranged to communicate via an intervening network 101 (such as but not limited to the Internet) with a platform 102 that comprises a point of sale terminal/PIN enabled device of choice. (Such platforms 102 are well known in the art and require no further elaboration here. Those skilled in the art will also appreciate that, in a typical embodiment, such an Internet Protocol-compatible network element 100 will likely communicate with a large plurality of such platforms 102; only one such platform 102 is shown here for the sake of clarity and simplicity of explanation.)

These teachings also generally provide for at least one transaction authorization host 103 that comprises a discrete platform vis-a-vis the Internet Protocol-compatible network element 100. This transaction authorization host 103 operably couples to the Internet Protocol-compatible network element 100 to facilitate the communications described below in more detail. Depending upon the needs and/or opportunities available in a given application context, this coupling may comprise, for example, a relatively direct connection between the transaction authorization host 103 and the Internet Protocol-compatible network element 100 or may comprise a connection via, for example, the aforementioned network 101. Such architectural considerations are also well known in the art. As these teachings are not particularly sensitive to any particular choice in this regard, further elaboration regarding this coupling need not be provided here.

Referring now to FIG. 2, the aforementioned Internet Protocol-compatible network element can be configured and arranged (via, for example, appropriate programming when the Internet Protocol-compatible network element comprises an at least partially programmable platform as is known in the art) to carry out a number of useful steps. This can comprise providing 201 PIN encryption key information to a PIN enabled device. By one approach this step can accord with, for example, the dictates and requirements of the EIS 1080 standard in this regard. Such PIN encryption key information can comprise, for example, a particular encryption key to use with encrypting a next PIN (or series of PINs) to be transmitted to the Internet Protocol-compatible network element. As another example this PIN encryption key information can comprise an identifier to specify a particular encryption key that the PIN enabled device already possesses.

This process 200 then provides for receiving 202 from the PIN enabled device a message that comprises, at least in part, information regarding a transaction to be authorized along with encrypted information that comprises a corresponding PIN that has been encrypted using the aforementioned PIN encryption key information. In response to receiving 202 such a message, this process 200 then provides for decrypting 203 the encrypted information to provide a recovered corresponding PIN. This, of course, differs markedly from prior art practice in this regard which would eschew such PIN decryption prior to reception of that PIN information by the target transaction authorization host.

This process 200 then provides for forwarding 204 the information regarding the transaction to be authorized along with the recovered corresponding PIN to a transaction authorization host. There are various ways by which this forwarding can be accommodated. For the purpose of illustration and not by way of limitation, some examples in this regard include (but are not limited to):
At least bifurcating these contents as between at least two segregated data frames (for example, by presenting the information regarding the transaction in a first data frame and the recovered corresponding PIN in a second data frame);
At least bifurcating these contents as between at least two segregated messages (for example, by presenting the information regarding the transaction in a first message (such as, for example, an authorization request) and the recovered corresponding PIN in a second message that is discrete with respect to the first message);
Forwarding the covered corresponding PIN in response to a message that is received from the transaction authorization host (wherein, for example, that message is received subsequent to having forwarded the information regarding the transaction to the transaction authorization host);
Nesting the corresponding PIN within the information regarding the transaction (as a discrete and whole item or as interleaved, for example, with the contents that comprise the information regarding the transaction); to note but a few.

Pursuant to these teachings, the encrypted PIN information is received and decrypted by the Internet Protocol-compatible network element before forwarding that content to the transaction authorization host. If desired, however, this forwarding can itself be conducted in a secure manner. In a typical embodiment, however, this will likely comprise encrypting the PIN information using an encryption key that is different from the aforementioned PIN encryption key information. By one approach this can comprise forwarding such information to the transaction authorization host using a secure tunnel (using, for example, such known techniques as Secure Socket Layer (SSL) and/or Internet Protocol Security (IPSec) (with those skilled in the art recognizing these techniques as comprising well known and understood approaches to Internet Protocol-based security; for example, IPSec comprises a standard for securing Internet Protocol communications by encrypting and/or authenticating all IP packets at the network layer). So configured, the PIN can remain relatively inviolate and protected during the forwarding step while nevertheless tending to ensure that the transaction authorization host remains largely computationally relieved as compared to the prior art practice of observing end-to-end usage of such practices as are stipulated by the EIS 1080 standard.

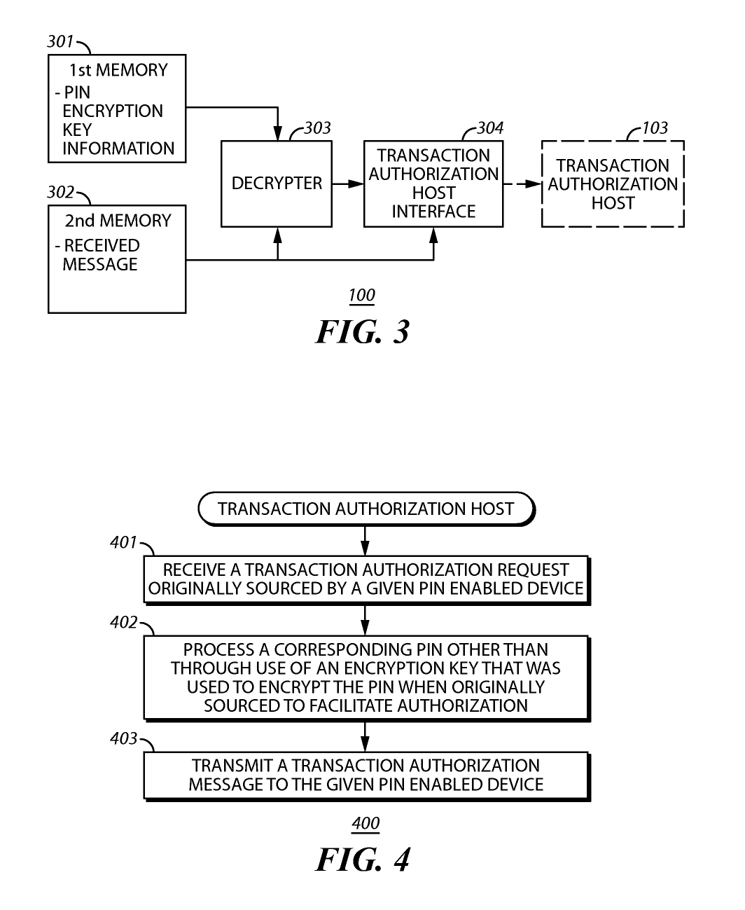

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment, the Internet Protocol-compatible network element 100 comprises a first memory 301 and a second memory 302 that operably couple to a decrypter 303. The first memory 301 serves, at least in part, to store the PIN encryption key information as was provided by the Internet Protocol-compatible network element 100 to the aforementioned PIN enabled device. The second memory 302 serves, in turn, to store the aforementioned message as was received from the PIN enabled device and that comprises the information regarding the transaction to be authorized along with the encrypted information that comprises the corresponding PIN. As already mentioned above, this corresponding PIN was encrypted using the PIN encryption key information.

So configured, the decrypter 303 uses the PIN encryption key information from the first memory 301 to decrypt and recover the corresponding PIN from the encrypted version there of as is provided by the second memory 302. The decrypter 303, in turn, operably couples via a decrypted recovered PIN output to a transaction authorization host interface 304 that also operably couples to the second memory 302. The transaction authorization host interface 304 is configured and arranged as appropriate to compatibly couple to the aforementioned transaction authorization host 103 to thereby facilitate provision of the transaction information along with the recovered corresponding PIN. These various constituent components can carry out these actions using any of the above mentioned techniques and approaches as may be appropriate to meet the specific needs and requirements of a given application setting.

Those skilled in the art will recognize and understand that such an Internet Protocol-compatible network element 100 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

By one approach, these teachings relieve the transaction authorization host of effecting the consistent end-to-end encryption/decryption required by such standards as the EIS 1080 standard. With reference to FIG. 4, this can comprise a corresponding transaction authorization host process 400 whereby the transaction authorization host receives 401 a transaction authorization request as was originally sourced by a given PIN enabled device. In the illustrative examples provided above, the aforementioned network element has first received that request and has decrypted the corresponding PIN before forwarding the request/PIN to the transaction authorization host via an appropriate forwarding mechanism (including but not limited to those specific examples provided above).

By this process 400 the transaction authorization host then processes 402 the PIN as corresponds to the transaction authorization request other than through use of an encryption key that was originally used by the PIN enabled device to encrypt the PIN to thereby facilitate authorization of the transaction authorization request. As noted above, this may comprise receiving the PIN in the clear and hence using the PIN without further decryption. As also noted above, this may comprise receiving the PIN via a secure approach of choice other than by use of the identical security mechanism as was originally used by the PIN enabled device when originally sourcing the request/PIN. This process 400 then provides for transmitting 403 a corresponding transaction authorization message to the given PIN enabled device.

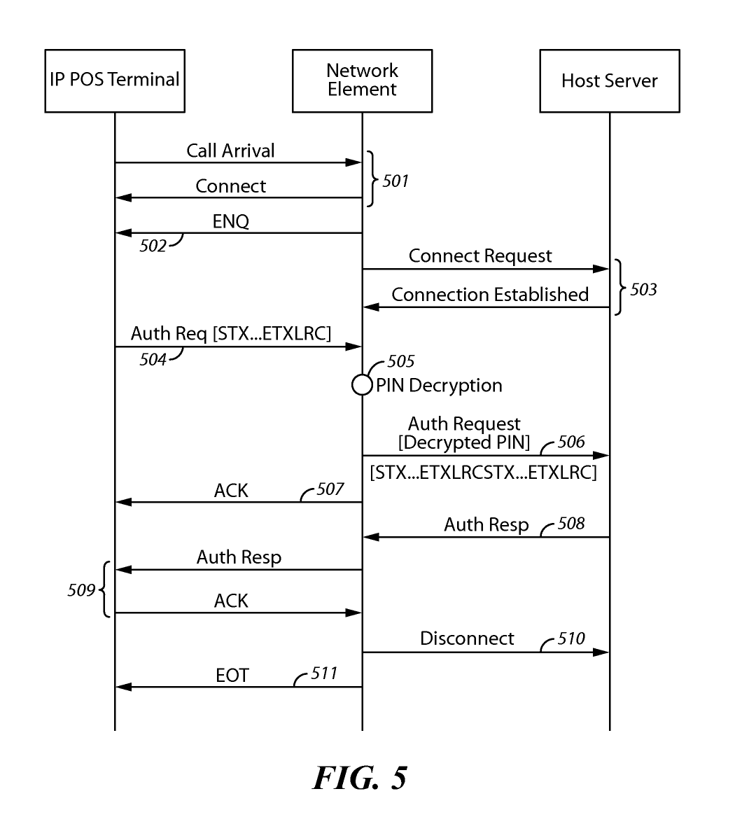

For the sake of further illustration and not by way of limitation, a more specific example in such regards will now be described with reference to FIG. 5. In this illustrative example, a Visa debit transaction that complies in its large respects with the mandates of EIS 1080 will demonstrate PIN decryption and forwarding by a network element other than a transaction authorization host.

In this example an Internet Protocol point-of-sale (IP POS) terminal initiates contact 501 with the network element in accordance with ordinary practice in this regard. The network element then provides an ENQ message 502 to the IP POS terminal (to invite transmission of the IP POS terminal's specific transaction authorization request) while also establishing a connection 503 with the corresponding transaction authorization host. The IP POS terminal, in accordance with EIS 1080 practice in this regard, then transmits its authorization request message 504 that contains a particularly encrypted version of the PIN as corresponds to the particular transaction for which authorization is sought.

By these teachings, the network element now decrypts 505 that decrypted PIN information rather than merely forward that encrypted information along to the transaction authorization host. In this particular illustrative example, the network element employs the aforementioned dual frame approach and forwards the authorization request along with the decrypted PIN 506 while also transmitting a correspond ACK 507 to the IP POS terminal to acknowledge receipt of the authorization request message.

In this example the transaction authorization host indeed authenticates this transaction and accordingly transmits an authorization response message 508 to the network element which in turn conducts an authorization response message forwarding and ACK response 509 with the IP POS terminal. This completes the transaction authorization process in this example and the network element can then disconnect 510 its connection with the transaction authorization host and disconnect 511 its connection with the IP POS terminal.

Those skilled in the art will understand and appreciate that these teachings provide for off-loading a transaction authorization host the computational loading that ordinarily accompanies the typical decryption of PIN information as provided by a point-of-sale platform. This, in turn, can significantly increase the capacity of the transaction authorization host to handle authorization requests for a larger population of such platforms. These teachings can be effected with only relatively small changes to existing transaction authorization hosts (of which there are relatively few) and with no required changes to PIN enabled devices whatsoever (of which there are literally millions in place and use).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an Internet Protocol-compatible network element:
providing personal identification number (PIN) encryption key information to a PIN enabled device;
receiving from the PIN enabled device a message comprising information regarding a transaction to be authorized and encrypted information comprising a corresponding PIN that has been encrypted using the PIN encryption key information;
decrypting the encrypted information to provide a recovered corresponding PIN;
forwarding the information regarding the transaction and the recovered corresponding PIN to a transaction authorization host that comprises a discrete network element with respect to the Internet Protocol-compatible network element.

2. The method of claim 1 wherein forwarding the information comprises presenting the information regarding the transaction in a first data frame and the recovered corresponding PIN in a second data frame.

3. The method of claim 1 wherein forwarding the information comprises presenting the information regarding the transaction in a first message and the recovered corresponding PIN in a second message that is discrete with respect to the first message.

4. The method of claim 3 wherein the first message comprises an authorization request.

5. The method of claim 1 wherein forwarding the information comprises forwarding the recovered corresponding PIN in response to a message that is received from the transaction authorization host.

6. The method of claim 5 wherein forwarding the recovered corresponding PIN in response to a message that is received from the transaction authorization host further comprises forwarding the recovered corresponding PIN in response to a message that is received from the transaction authorization host subsequent to forwarding the information regarding the transaction to the transaction authorization host.

7. The method of claim 1 wherein forwarding the information comprises forwarding the recovered corresponding PIN as nested within the information regarding the transaction.

8. The method of claim 1 wherein forwarding the information comprises forwarding the recovered corresponding PIN as encrypted using an encryption key that is different than the PIN encryption key information.

9. The method of claim 1 wherein forwarding the information comprises forwarding the information using a secure tunnel.

10. The method of claim 9 wherein the secure tunnel is formed using at least one of:
Secure Socket Layer;
IPSec.

11. An Internet Protocol-compatible network element comprising:
a first memory having stored therein personal identification number (PIN) encryption key information as has been provided by the Internet Protocol-compatible network element to a PIN enabled device;
a second memory having stored therein a message received from the PIN enabled device comprising information regarding a transaction to be authorized and encrypted information comprising a corresponding PIN that has been encrypted using the PIN encryption key information;
a decrypter operably coupled to the first memory and the second memory and having a decrypted recovered PIN output;
a transaction authorization host interface operably coupled to the second memory and the decrypted recovered PIN output and being configured and arranged to forward the information regarding the transaction and the decrypted recovered PIN to a transaction authorization host that comprises a discrete network element with respect to the Internet Protocol-compatible network element.

12. The Internet Protocol-compatible network element of claim 11 wherein the information comprises a first data frame comprising the information regarding the transaction and a second data frame comprising the recovered corresponding PIN.

13. The Internet Protocol-compatible network element of claim 11 wherein the information comprises a first message comprising the information regarding the transaction and a second message that is discrete with respect to the first message that comprises the recovered corresponding PIN.

14. The Internet Protocol-compatible network element of claim 13 wherein the first message comprises an authorization request.

15. The Internet Protocol-compatible network element of claim 11 wherein the information comprises a message being provided in response to a message that is received from the transaction authorization host.

16. The Internet Protocol-compatible network element of claim 11 wherein the information comprises an encrypted version of the recovered corresponding PIN as encrypted using an encryption key that is different than the PIN encryption key information.

17. The Internet Protocol-compatible network element of claim 11 wherein transaction authorization host interface comprises a secure tunnel.

18. The Internet Protocol-compatible network element of claim 17 wherein the secure tunnel comprises at least one of:
a Secure Socket Layer;
IPSec.

19. A method comprising:
at a transaction authorization host:
receiving a transaction authorization request as was originally sourced by a given personal identification number (PIN) enabled device;
processing a PIN as corresponds to the transaction authorization request other than through use of an encryption key that was used to encrypt the PIN when originally sourcing the transaction authorization request to thereby facilitate authorization of the transaction authorization request;
transmitting a transaction authorization message to the given PIN enabled device.

20. The method of claim 19 wherein receiving a transaction authorization request as was originally sourced by the given PIN enabled device comprises receiving information regarding the transaction in a first data frame and a non-encrypted version of the PIN in a second data frame.

21. The method of claim 19 wherein receiving a transaction authorization request as was originally sourced by the given PIN enabled device comprises receiving information regarding the transaction in a first message and a non-encrypted version of the PIN in a second message that is discrete with respect to the first message.

22. The method of claim 19 wherein receiving a transaction authorization request as was originally sourced by the given PIN enabled device comprises:
receiving information regarding the transaction in a first message;
transmitting a subsequent message;
receiving, in response to transmitting the subsequent message, the PIN.

23. The method of claim 19 wherein receiving a transaction authorization request as was originally sourced by the given PIN enabled device comprises receiving information via a secure tunnel.

24. The method of claim 23 wherein the secure tunnel comprises at least one of:
a Secure Socket Layer;
an IPSec.
